(19) United States
(12) Patent Application Publication
(10) Pub. No.: US 2004/0208079 A1
(43) Pub. Date: Oct. 21, 2004

(54) Method and apparatus for removing entrapped air from viscous materials

(76) Inventor: Gregory S. Hein, Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/419,365

(22) Filed: Apr. 21, 2003

(51) Int. Cl. B28C 5/46

(52) U.S. Cl. 366/6; 366/56; 366/139; 106/638; 106/713

(57) ABSTRACT

A method and apparatus for mixing viscous material, includes placing ingredients of the viscous material within a vessel. An air tight seal is created about the vessel. A vacuum is pulled on the vessel, and the ingredients are mixed within the vessel to form the viscous material while under vacuum. The vacuum is sufficient to reduce the amount of total air content in viscous material to between 0.9% and 0.1% by volume prior to an air entraining agent being added to the viscous material. Once air entraining agent is added, further mixing of the ingredients forms entrained air content in the final viscous material, while the amount of entrapped air in the final viscous material remains reduced.

### BACKGROUND OF THE INVENTION

The present invention relates to the field of processing viscous materials. More particularly, this invention relates to a means and method for the removal of entrapped air from viscous materials which will allow for the ultimate control of the air content during the production and use of such materials. Specific examples of viscous materials to which the invention is particularly applicable include but are not limited to concrete, architectural materials, asphalt, composite cement mixes, precast concrete, ready mixed concrete, architectural concrete, mortar, and grout.

The viscous nature of some materials makes the control of the air content rather difficult in light of the many processes and requirements for such materials. Concrete, for example, is much stronger the lesser the total air content within its cement and aggregate matrix; however, it has not proven to be a very durable material when subject to extreme conditions at lower total air contents. Strict agency and governmental requirements mandate the need for total air content within concrete to maintain total air content between a range of percentages. The desired amount of total air content is generally from 4.0 to 7.5 percent of the total mix. The total air content of concrete and other viscous materials of high viscosity, such as asphalt, can not be controlled to a very close tolerance when produced using current practices. The total air content can only be controlled within ±1% at best using current practices.

The total air content of viscous materials is made up of entrained air voids and entrapped air voids. Entrained air is desirable and is obtained in the viscous material by using either an air entraining cement, or adding an air entraining agent during the mixing process. An air entraining agent is added to the concrete mix so that enough air will be entrained to improve workability and durability of the mixture, but not enough to reduce strength substantially. Entrained air bubbles are extremely small in size and vary generally between 10 to 100 μm. Entrapped air bubbles are 1000 μm or larger, and are not a desirable component of the total air content in a viscous material. This entrapped air raises the total air content of the viscous material without providing the benefits of entrained air. Further, the entrapped air adversely affects the permeability, tensile strength, and the compressive strength of the viscous material. Current industry practices do not directly control the amount of entrapped air in a given viscous material, and the presence of entrapped air is treated as an unavoidable byproduct of processing. Because of this, there is no research related to the controlled production or use of a viscous material, such as concrete, limiting the content of entrapped air.

Therefore, a principal object of this invention is to provide a method and means for reducing the amount of entrapped air in the final viscous material.

A further object of the invention is to provide a method and means for processing viscous material under a vacuum.

Another object of the invention is to provide a method and means for reducing the amount of total air content in viscous material prior to the addition of an air entraining agent.

These and other objects will be apparent to those skilled in the art.

### SUMMARY OF THE INVENTION

A method and apparatus for mixing viscous material, includes placing ingredients of the viscous material within a vessel. An air tight seal is created about the vessel. A vacuum is pulled on the vessel, and the ingredients are mixed within the vessel to form the viscous material while under vacuum. The vacuum is sufficient to reduce the amount of total air content in viscous material to between 0.9% and 0.1% by volume prior to an air entraining agent being added to the viscous material. Once air entraining agent is added, further mixing of the ingredients forms entrained air content in the viscous material, while the amount of entrapped air in the final viscous material remains reduced.

### DESCRIPTION OF THE DRAWINGS

FIG. 1 is a side view of the device of this invention; and

FIG. 2 is an enlarged sectional view of the device of this invention taken on line 2-2 of FIG. 1.

### DESCRIPTION OF THE PREFERRED EMBODIMENT

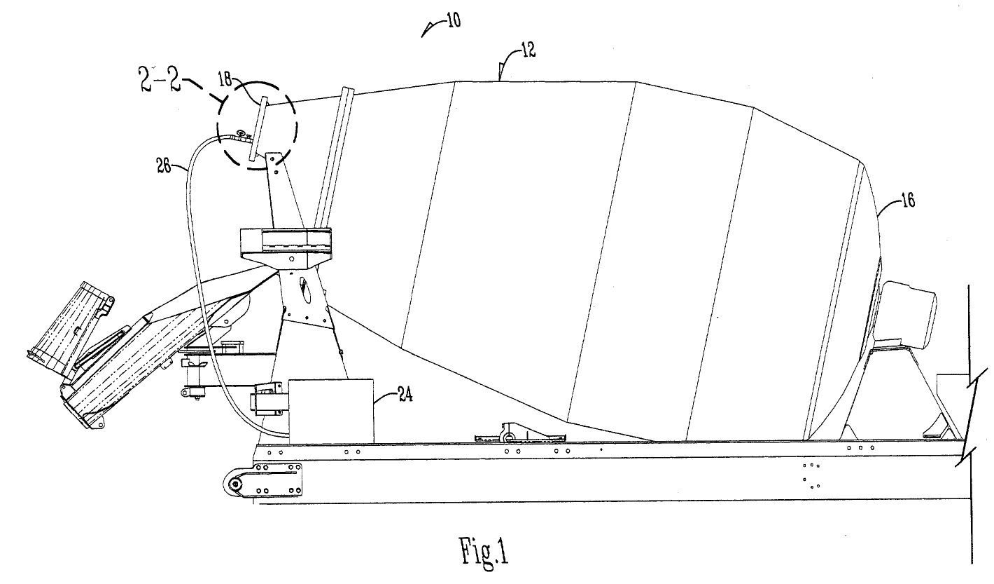

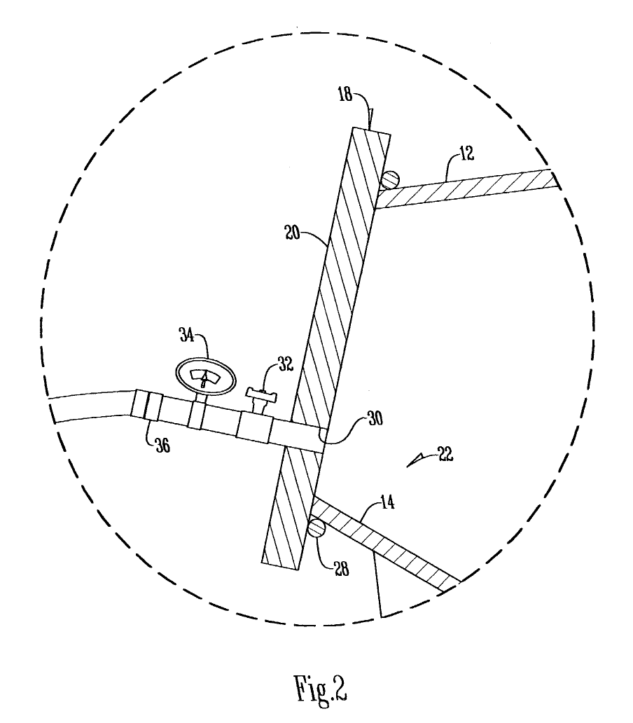

With reference to FIGS. 1 and 2, a material mixing system 10 for mixing viscous material includes a vessel 12. The vessel 12 receives ingredients of the viscous material through aperture 14 and rotates to act as a mixing element 16 to mix the viscous material ingredients contained within the vessel 12. While the vessel 12 and the mixing element 16 are shown as the rotatable barrel of a cement mixer, one of ordinary skill in the art will understand that the mixing element 16 may be provided separate from vessel 12 without departing from the present invention. Further, it will be understood that the apparatus of the present invention may include mobile or stationary mixers and that the present invention may be used to permanently or removably retrofit any commercially available mixer.

It will be understood to one of ordinary skill in the art that the term “viscous material” as used herein includes, but is not limited to concrete, architectural materials, asphalt, composite cement mixes, precast concrete, ready mixed concrete, architectural concrete, precast concrete, mortar, and grout.

A seal element 18 is shown as an end plate covering 20 associated with aperture 14 to create an air tight enclosed space 22 within the vessel 12. The seal element 18 may be removably affixed to the vessel 12 in any conventional manner, including but not limited to vacuum pressure or fasteners (not shown).

A vacuum source 24 is associated in gaseous flow communication with the enclosed space 22 via vacuum hose 26 connecting the vacuum source 24 to seal element 18. The vacuum source 24 pulls a vacuum on the viscous material ingredients within the enclosed space 22 while the mixing element 16 is mixing the ingredients. The vacuum source 24 pulls a given level of vacuum on the viscous material ingredients sufficient to reduce the amount of total air content in viscous material prior to air entraining agent being added to the viscous material.

The vacuum source 24 pulls varying levels of vacuums on the enclosed space 22 at given temperature ranges so to avoid reaching the vapor pressure of water. Alternatively, a vacuum exceeding the vapor pressure of water is provided where removal of excess water is desired.

An o-ring element 28 is positioned between the end plate 20 and the vessel 12 to create and maintain the air tight seal about aperture 14.

An orifice 30 is provided passing through the seal element 18. The orifice 30 is connected in gaseous flow communication between the vacuum hose 26 and the enclosed space 22, to allow gas to pass through the seal element 18 to the vacuum source 24.

A vacuum valve 32 is connected directly to the orifice in gaseous flow communication between the orifice 30 and the vacuum source 24 along the vacuum hose 26. Alternatively, the vacuum valve 32 may be located anywhere between the orifice 30 and the vacuum source 24. The vacuum valve 32 operates to incrementally restrict gaseous flow through the vacuum hose 26.

A vacuum gauge 34 is connected directly to the vacuum valve 32 in gaseous flow communication between the orifice 30 and the vacuum source 24. Alternatively, the vacuum gauge 34 may be located anywhere between the vacuum valve 32 and the vacuum source 24. The vacuum gauge 34 provides a measure of the vacuum being pulled on the vessel 12 to an operator or an electronic control device (not shown).

A swivel element 36 is rotatably associated directly to the vacuum gauge 34 in gaseous flow communication with the vacuum hose 26 between the orifice 30 and the vacuum source 24. Alternatively, the swivel element 36 may be located anywhere between the orifice 30 and the vacuum hose 26. The swivel element 36 permits the vacuum hose 26 to remain relatively stationary, or to prevent the vacuum hose 26 from twisting, while the seal element 18 rotates with the mixing element 14 during mixing of the viscous material.

An air compressor (not shown) may be optionally provided to improve the efficiency of the vacuum source 24. If desired, the air compressor would be associated in gaseous flow communication with the vacuum hose 26 between the orifice 30 and the vacuum source 24.

As previously discussed, the total air content of viscous materials is made up of entrained air voids and entrapped air voids. The mixing of viscous material ingredient under vacuum, and prior to the introduction of an air entraining agent, results in forming a matrix of intermediate viscous material composition having a reduced total air content. As entrapped air is primarily formed prior to the addition of air entraining agent, this reduction in total air content results in a proportional reduction in the amount of entrapped air content. By applying a vacuum to the viscous material during mixing, the total air content is reduced to between 0.9% and 0.1% by volume. A total air content of between 0.4% and 0.1% by volume can also be achieved.

The addition of air entraining agent after the total air content has been reduced, and further mixing of the ingredients will form entrained air content in a final viscous material. The reduction of the entrapped air content under vacuum, prior to the addition of air entraining agent, reduces the amount of entrapped air in the final viscous material. Thus, the final viscous material has an increased percentage of entrained air and a decreased percentage of entrapped air.

The test data below was prepared using a method in which all pertinent industry standards including American Society for Testing and Materials (ASTM) Code requirements and specifications were met. All tests were conducted per the ASTM code specifications, performed and/or overseen by an American Concrete Institute (ACI) certified concrete field testing technician, as well as observed by a Prestressed/Precast Concrete Institute (PCI) level 3 inspector to verify all tests were conducted in a fashion deemed suitable for a prestressed and/or precast concrete environment.

The resulting test data below illustrates the difference between the three mixes: Mix #1 subject to the vacuum with no air entrainer added, Mix #2 subject to the vacuum and with air entrainer added, and Mix #3 not subject to the vacuum and with air entrainer added (used as a prior art control). All three mixes used the same proportions of cement, pozzolan, stone, sand, and water during the testing. The vacuum and apparatus were attached to the mixer and underwent the vacuum to 27″ Hg for Mix #1 and #2.

Additionally, a “target” result is shown in the table, which lists the target properties for Mix #3 (prior art control) predicted by industry standards. The predicted “target” strength for Mix #3 was 6000 psi and the target air content was 5.5%±1.5%.

TABLE #1

| | Mix #1 | Mix #2 | Mix #3 | Target |
|---|---|---|---|---|
| Vacuum | Yes | Yes | No | No |
| Air entraining agent | No | Yes | Yes | Yes |
| 28 day Compressive | 9002 | 8018 | 7640 | 6000 |
| Strength Average | | | | |
| (fc′) (psi) | | | | |
| Standard Deviation | 211.92 | 334.18 | 651.28 | 611 |
| (Strength) | | | | |
| Average Air Content | 0.23 | 5.85 | 4.98 | 5.5 |
| (%) | | | | |
| Unit Weight (pcf) | 153 | 145 | 144 | 150 |
| Average Compressive | 6284 | 6447.8 | 7017.5 | 7000 |
| Strength (fcr′) | | | | |
| (psi) | | | | |
| % Strength Increase | 50 | 34 | 27 | NA |
| from Target | | | | |

These test results reveal that use of the vacuum results in greater control or predictability of total air content in the final product. Using the vacuum, air content tolerances were found to be ±0.5%, which is a significant improvement over industry standards which specify ±1.5% as the range of air content tolerance.

A reduction of entrapped air content in the final product was also achieved in the above test results. Using prior art practices, the mixing of ingredients to form viscous material prior to the addition of an air entraining agent can only achieve a 1% to 1.5% total air content (by volume). In Table #1, the mixtures formed using the present invention achieved total air contents of 0.4%, 0.3%, and 0.1% (by volume), prior to the addition of air entraining agent. It can be assumed that the total air content at this stage of processing is purely entrapped air, as no air entraining agent has been added. Accordingly, the present invention produced a significant decrease in entrapped air content to 0.4%, 0.3%, and even as low as 0.1% (by volume). It is believed that even lower percentages are achievable by this invention.

The test results reveal that not only can the present invention remove the entrapped air from the concrete to within ±0.1% of total air content removal, but the concrete was found to have a resulting compressive strength 10-25% higher than the mean of the average mix for a given mix design; the standard deviation was found to be less than the ACI-318 specified standard deviation range; and therefore the strengths were within more predictable ranges than are typically used as a standard in the concrete industry.

The present invention increases bonding strength at aggregate/cement interfaces in several ways. This increased bonding strength results from the improved dispersion of entrained air voids since disruptions due to entrapped air are largely reduced. Additionally, the incorporation of a vacuum apparatus into the mixing process creates an environment which allows the fine/course aggregate, cement, and other additives to a given material mix bond with no interfacial pressures interfering with the material's matrix bond. Further, the removal of entrapped air from micropores and microcracks in the aggregate allows a stronger bonding between aggregates and the cement paste, for concrete. The same mechanisms would apply equally to other viscous materials. The increased bonding strength causes an increased compressive strength, increased rupture strength (tensile strength), and an increase in the Young's Modulus of the material.

Greater control or predictability of the strength of the final product is also shown with the use of vacuum pressure. The narrower standard deviation for concrete produced by the present invention provides an increased predictability of viscous material strength. Thus, fewer tests are needed to verify the strength of a viscous material made by the process of the present invention.

Additionally, further tests revealed that the durability to freeze-thaw conditions between Mix #1 and Mix #3 were not found to be substantially different. This is a surprising result as Mix #1 had very low total air content while Mix #3 had a comparatively high average total air content of 4.98% with respect to Mix #1. Under conventional practices, it is assumed that the higher the total air content, the greater the resistance to freeze-thaw conditions. The present inventions removal of the detrimental entrapped air allowed the low total air content Mix #1 to have similar durability to freeze-thaw conditions to Mix #3. This result indicates that for a mix requiring a specified total air content, the process of the present invention provides increased resistance to freeze-thaw conditions.

Further, further tests revealed that the permeability of the concrete subject to the vacuum was found to be reduced by 75-100%. The porosity of the concrete subject to the vacuum was decreased in conjunction with the reduced permeability.

The above tests indicate that the present invention directly increases density, increases resistance to freeze-thaw, decreases permeability, and decreases porosity; as well as indirectly increases corrosion resistance, increases the retention period of high alkalinity levels, and decreases chloride penetration in viscous materials.

It is therefore seen that the present invention provides a method and means capable of processing viscous material under a vacuum. The present invention further provides a method and means capable of reducing the amount of total air content in viscous material prior to the addition of an air entraining agent. The present invention also provides a method and means capable of reducing the amount of entrapped air in the final viscous material.

It is therefore seen that this invention will accomplish at least all of its stated objectives.

I claim:

1. A material mixing system, for use with a concrete mixer having a vessel and a mixing element, for processing viscous material, comprising:
a seal element adapted to associate with an aperture in the vessel to create an air tight enclosed space within the vessel; and
a vacuum source associated in gaseous flow communication with the seal element and adapted to pull a vacuum on the enclosed space while the mixing element is mixing viscous material within the cement mixer.

2. The apparatus of claim 1, wherein the vessel and the mixing element are a rotatable barrel of a cement mixer.

3. The apparatus of claim 1, wherein the seal element is an end plate covering the aperture in the vessel.

4. The apparatus of claim 3, wherein the end plate is affixed to the aperture by vacuum pressure.

5. The apparatus of claim 3, wherein the seal element further comprises an o-ring element positioned between the end plate and the vessel to create the air tight enclosed space.

6. The apparatus of claim 1, wherein the seal element has an orifice therethrough and wherein a vacuum hose is associated between the orifice and the vacuum source.

7. The apparatus of claim 6, further comprising a swivel element rotatably associated in gaseous flow communication with the vacuum hose between the orifice and the vacuum hose to permit the vacuum hose to remain stationary while the seal element rotates.

8. The apparatus of claim 6, further comprising a vacuum valve and a vacuum gauge, each associated in gaseous flow communication with the vacuum hose between the orifice and the vacuum source.

9. The apparatus of claim 6, further comprising an air compressor associated in gaseous flow communication with the vacuum hose between the orifice and the vacuum source.

10. A method of mixing viscous material, comprising:
placing ingredients of the viscous material within a vessel;
creating an air tight seal about the vessel;
pulling a vacuum from within the vessel; and
mixing the ingredients within the vessel to form the viscous material while under vacuum.

11. The method of claim 10, wherein the viscous material is selected from one of the group comprising concrete, architectural materials, asphalt, composite cement mixes, precast concrete, ready mixed concrete, architectural concrete, pre-stressed concrete, mortar, and grout.

12. The method of claim 10, wherein the vacuum is sufficient to reduce the amount of total air content in viscous material prior to air entraining agent being added to the viscous material.

13. The method of claim 12, wherein the total air content is between 0.9% and 0.1% by volume.

14. The method of claim 12, wherein the total air content is between 0.4% and 0.1% by volume.

15. The method of claim 10, further comprising the step of adding air entraining agent after the total air content has been reduced, further mixing the ingredients to form entrained air content in a final viscous material, wherein the vacuum is sufficient to reduce the amount of entrapped air in the final viscous material.

16. An intermediate viscous material composition, comprising:
a matrix of intermediate viscous material and air voids;
wherein the intermediate viscous material is selected from the group consisting of concrete, architectural materials, asphalt, composite cement mixes, precast concrete, ready mixed concrete, architectural concrete, mortar, and grout; and
wherein the total air content is between 0.9% and 0.1% by volume.

17. The method of claim 16, wherein the total air content is between 0.4% and 0.1% by volume.

18. The method of claim 16, wherein the intermediate viscous material is combined with an air entraining agent and mixed to form a final viscous material with the entrapped air content in the final viscous material remaining reduced.

19. A material mixing system for mixing viscous material, comprising:
a vessel adapted to receive ingredients of the viscous material;
a mixing element adapted to mix the ingredients within the vessel;
a seal element associated with the vessel to create an air tight enclosed space; and
a vacuum source associated in gaseous flow communication with the enclosed space, wherein the vacuum source pulls a vacuum on the enclosed space while the mixing element is mixing.
